(19) United States
(12) Patent Application Publication
(10) Pub. No.: US 2021/0034824 A1
(43) Pub. Date: Feb. 4, 2021

(54) MACHINE TRANSLATION CONTROL DEVICE

(71) Applicant: NTT DOCOMO, INC., Chiyoda-ku (JP)

(72) Inventors: Takaya ONO, Chiyoda-ku (JP); Satoru MIZOGUCHI, Chiyoda-ku (JP); Yoshinori ISODA, Chiyoda-ku (JP)

(73) Assignee: NTT DOCOMO, INC., Chiyoda-ku (JP)

(21) Appl. No.: 17/041,209

(22) PCT Filed: Jul. 18, 2019
(86) PCT No.: PCT/JP2019/028349

§ 371 Date: Sep. 24, 2020

(30) Foreign Application Priority Data
Aug. 24, 2018 (JP) 2018-157554

(51) Int. Cl. G06F 40/58

(52) U.S. Cl. CPC G06F 40/58

(57) ABSTRACT

A machine translation control device includes: an extraction unit configured to extract one or more frequent sentences from input sentences to machine translation with reference to a use log in a machine translation engine that performs machine translation using a machine translation model; an acquisition unit configured to acquire one or more similar sentences which are similar to the extracted frequent sentence and a similar translated sentence which is a translation of the similar sentence from a translation DB; and a tuning unit configured to tune the machine translation model on the basis of the acquired similar sentence and the acquired similar translated sentence.

### TECHNICAL FIELD

An aspect of the present invention relates to a machine translation control device for improving translation quality in a machine translation engine that performs machine translation using a machine translation model.

### BACKGROUND ART

Machine translation of translating a sentence from a certain language to another language using mainly a computer program has spread. In such machine translation, it is very important to improve translation quality (quality of translation). In the related art, in order to achieve improvement in translation quality of machine translation which is actually used, the following measures are generally taken on the basis of an actual use log.

First, the use log is evaluated by a person who has language skills in both the input language and the output language of the machine translation (hereinafter referred to as a “highly skilled person”), and correct answer data (a correct answer sentence) is prepared when there is an error in the machine translation. Then, analysis based on evaluation data which is acquired through the evaluation is performed, and tuning of a machine translation model using the correct answer data or the like is performed.

### CITATION LIST

### Patent Literature

Patent Literature 1: Japanese Unexamined Patent Publication No. 2000-154595

### SUMMARY OF INVENTION

### Technical Problem

However, since small amounts of evaluation data, correct answer data, and the like are not effective for improvement in translation quality, the amounts of data need to be equal to or greater than predetermined amounts, and there are problems in that a highly skilled person needs to evaluate a large amount of use log, and work time and cost for improvement in translation quality increase.

On the other hand, various sentences which are input to machine translation may include sentences which appear frequently (hereinafter referred to as a “frequent sentence”) and sentences which rarely appear (see Patent Literature 1). When a frequent sentence is not correctly translated and thus translation quality is poor, a user who uses machine translation may be subjected to a substantial loss and a sensitive loss and thus there is demand for rapid improvement in translation quality.

In consideration of the above-mentioned problems, an objective of an aspect of the present invention is to curb an increase in work time and cost for improvement in translation quality, to achieve improvement in translation quality for a frequent sentence, and to improve convenience for users.

### Solution to Problem

In order to achieve the above-mentioned objective, according to an aspect of the invention, there is provided a machine translation control device including: an extraction unit configured to extract one or more frequent sentences from input sentences to machine translation with reference to a log in a machine translation engine that performs machine translation using a machine translation model; an acquisition unit configured to acquire one or more similar sentences which are similar to the frequent sentence extracted by the extraction unit and a similar translated sentence which is a translation of the similar sentence from a translation database that stores translation data of machine translation; and a tuning unit configured to tune the machine translation model on the basis of the similar sentence and the similar translated sentence acquired by the acquisition unit.

According to this aspect, in the machine translation control device, the extraction unit extracts one or more frequent sentences from input sentences to machine translation with reference to a use log in a machine translation engine, the acquisition unit acquires one or more similar sentences which are similar to the extracted frequent sentence and a similar translated sentence which is a translation of the similar sentence from the translation database, and the tuning unit tunes the machine translation model on the basis of the acquired similar sentence and the acquired similar translated sentence. “Similar sentence” refers to a sentence which is in a predetermined similarity range and includes the same sentence. In this way, by additionally providing the machine translation control device in the existing machine translation engine and the existing translation database, tuning of the machine translation model based on a similar sentence similar to a frequent sentence and a similar translated sentence is performed using the translation database without a highly skilled person evaluating the use log or the like as in the related art. Accordingly, it is possible to curb an increase in work time and cost for improvement in translation quality, to achieve improvement in translation quality for a frequent sentence, and to improve convenience for users.

### Advantageous Effects of Invention

According to the aspect of the invention, it is possible to curb an increase in work time and cost for improvement in translation quality, to achieve improvement in translation quality for a frequent sentence, and to improve convenience for users.

### BRIEF DESCRIPTION OF DRAWINGS

FIG. 1 is a functional block diagram illustrating an example of a functional configuration of a machine translation control device according to an embodiment of the invention.

FIG. 2 is a flowchart illustrating an example of a process flow which is performed by the machine translation control device.

FIG. 3 is a flowchart illustrating an example of a process of extracting a frequent sentence.

FIG. 4 is a flowchart illustrating an example of a process of acquiring a similar sentence and a similar translated sentence.

FIG. 5 is a flowchart illustrating an example of a process of tuning a machine translation model.

FIG. 6 is a diagram illustrating an example of a hardware configuration of the machine translation control device.

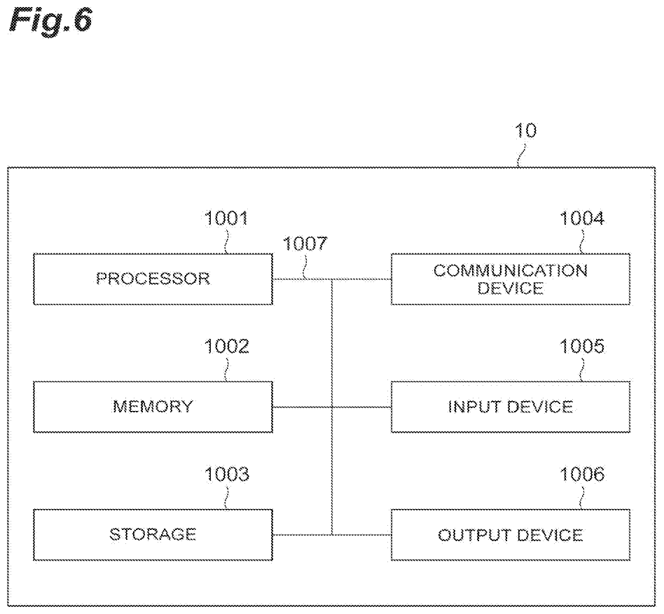

### DESCRIPTION OF EMBODIMENTS

Hereinafter, an embodiment of the present invention will be described with reference to the accompanying drawings. In description with reference to the drawings, the same elements will be referred to by the same reference signs and description thereof will not be repeated.

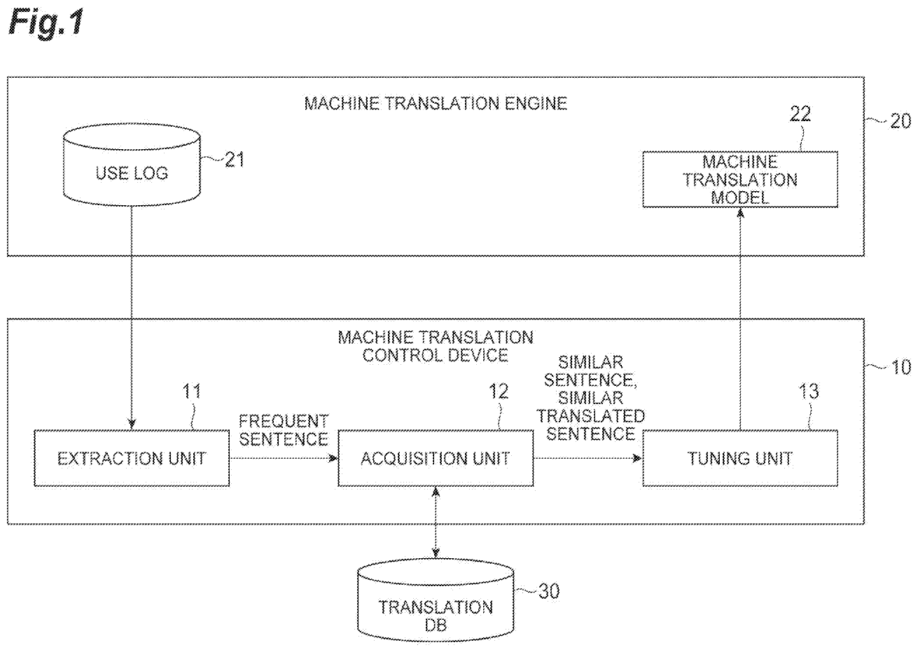

As illustrated in FIG. 1, a machine translation control device 10 according to an embodiment is a device that is configured to refer to a use log 21 in an existing machine translation engine 20 that performs machine translation using a machine translation model 22 and to search an existing translation database (a translation DB) 30 in which translation data of the machine translation is stored, and has a function of tuning the machine translation model 22 for improvement in translation quality of the machine translation.

More specifically, the machine translation control device 10 includes an extraction unit 11 configured to extract one or more frequent sentences from input sentences to machine translation with reference to the use log 21 in the machine translation engine 20, an acquisition unit 12 configured to acquire one or more similar sentences similar to the extracted frequent sentence and a similar translated sentence which is a translation of the similar sentence from the translation DB 30, and a tuning unit 13 configured to tune the machine translation model 22 in the machine translation engine 20 on the basis of the acquired similar sentence and the acquired similar translated sentence.

In this configuration, the extraction unit 11 may extract a frequent sentence by performing classification of input sentences to the machine translation or may extract a frequent sentence on the additional basis of a frequency of an expression when there are a plurality of frequent expressions.

The acquisition unit 12 may acquire the similar sentence on the additional basis of a similarity based on a predetermined criterion when there are a plurality of similar sentences similar to the frequent sentence.

The tuning unit 13 may perform model learning, for example, on the basis of the similar sentence and the similar translated sentence, evaluate the machine translation model subjected to model learning, and tune the machine translation model in the machine translation engine on the basis of a result of evaluation.

FIG. 1 illustrates an example in which the machine translation control device 10 is constituted separately from the machine translation engine 20 and the translation DB 30. That is to say, the extraction unit 11 is configured to refer to the use log 21 in the machine translation engine 20 which is provided outside, and the acquisition unit 12 is configured to acquire a similar sentence and a similar translated sentence from the translation DB 30 which is provided outside. Here, the above-mentioned separated configuration is not necessary and a configuration different therefrom, for example, a configuration in which the machine translation control device 10 is constituted integrally with one or both of the machine translation engine 20 and the translation DB 30, may be employed.

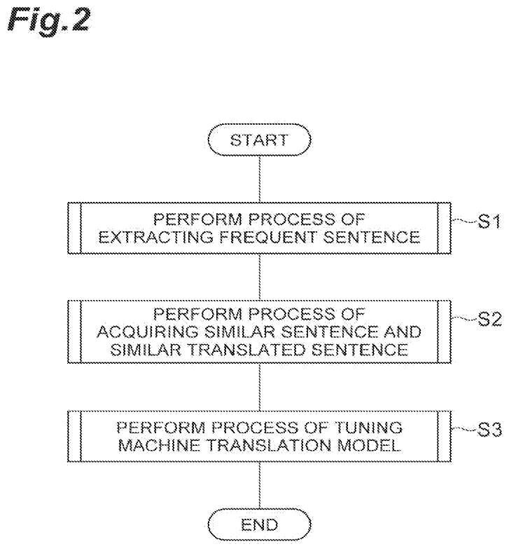

An example of a process flow which is performed by the machine translation control device 10 will be described below with reference to FIGS. 2 to 5.

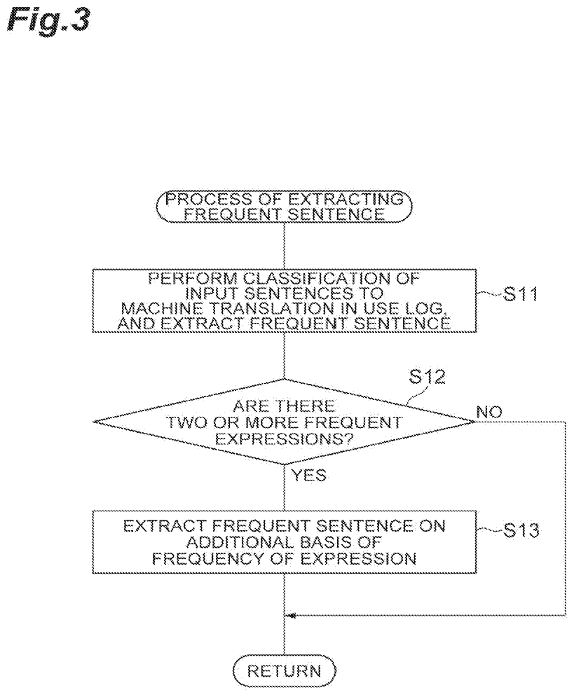

As illustrated in FIG. 2, as the whole image of the process flow, at first, the extraction unit 11 performs an extraction process of extracting one or more frequent sentences from input sentences to the machine translation with reference to the use log 21 in the machine translation engine 20 (Step S1). Then, the acquisition unit 12 performs an acquisition process of acquiring one or more similar sentences similar to the extracted frequent sentence and a similar translated sentence which is a translation of the similar sentence from the translation DB 30 (Step S2), and the tuning unit 13 additionally performs a process of tuning the machine translation model 22 in the machine translation engine 20 on the basis of the acquired similar sentence and the acquired similar translated sentence (Step S3). A start trigger of the process flow illustrated in FIG. 2 is not limited to a specific trigger and, for example, the process flow may be started at predetermined periodic times or may be started in response to an operator's predetermined operation or the like. Examples of the processes of Steps S1 to S3 will be described below with reference to FIGS. 3 to 5.

As illustrated in FIG. 3, in the extraction process of Step S1, the extraction unit 11 performs classification of input sentences to machine translation in the use log and extracts a frequent sentence (Step S11). The appearance frequency which serves as a basis of extraction thereof is not limited to a specific one. Here, it is determined whether there are a plurality of frequent expressions (Step S12). When there are a plurality of frequent expressions, the extraction unit 11 extracts a frequent sentence on the additional basis of a frequency of an expression (Step S13). The extracted frequent sentence is transmitted to the acquisition unit 12.

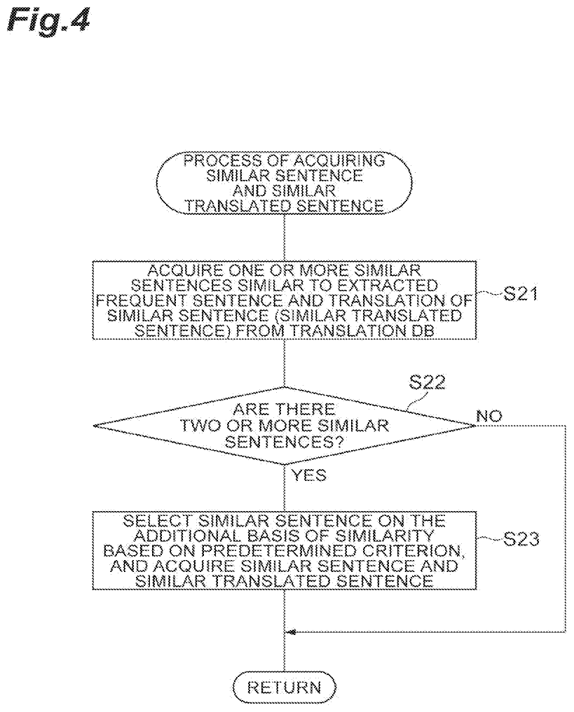

As illustrated in FIG. 4, in the acquisition process of Step S2, the acquisition unit 12 acquires one or more similar sentences similar to the extracted frequent sentence and a translation of the similar sentence (a similar translated sentence) from the translation DB 30 (Step S21). Here, “similar sentence” refers to a sentence which is in a predetermined similarity range and includes the same sentence. A method of acquiring a similar sentence is not limited to a specific method and an existing method may be employed. At this time, an existing method such as term frequency-inverse document frequency (tf-idf), Latent Dirichlet Allocation (LDA), or word2vec may be employed as the method of calculating a similarity between sentences. Here, it is determined whether there are a plurality of similar sentences (Step S22), and when there are a plurality of similar sentences, the acquisition unit 12 selects a similar sentence on the additional basis of a similarity based on a predetermined criterion which is different from that in Step S21 and acquires the selected similar sentence and a similar translated sentence of the similar sentence from the translation DB 30 (Step S23). The acquired similar sentence and the acquired similar translated sentence are transmitted to the tuning unit 13.

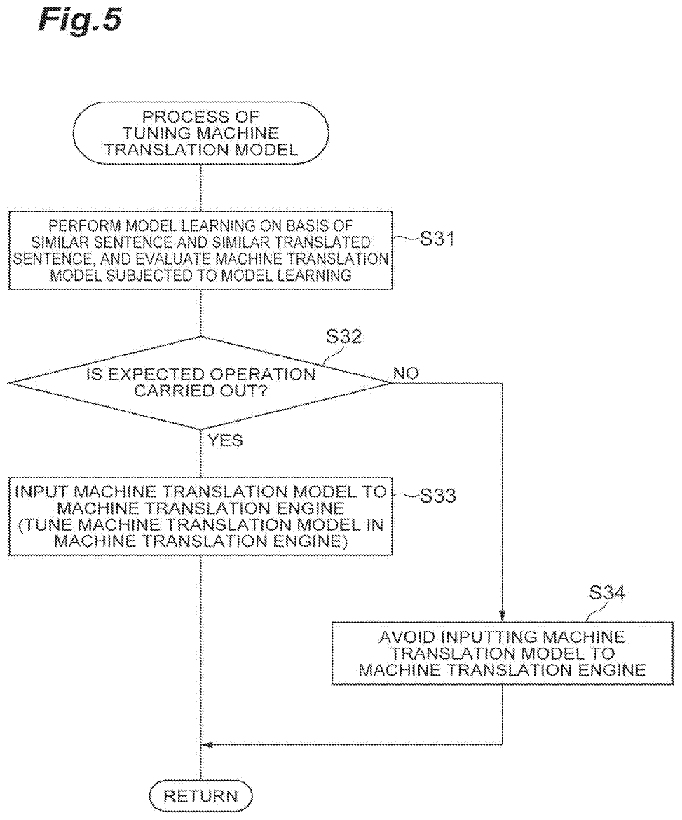

As illustrated in FIG. 5, in the tuning process of Step S3, the tuning unit 13 performs model learning on the basis of a similar sentence and a similar translated sentence and evaluates the machine translation model subjected to model learning (Step S31). Here, as the result of evaluation, it is determined whether an expected operation is carried out (Step S32). The method of determination is not limited to a specific method, and an existing method may be employed. When it is determined that an expected operation is carried out, the tuning unit 13 inputs the machine translation model to the machine translation engine 20. That is to say, the machine translation model 22 in the machine translation engine 20 is tuned (Step S33). On the other hand, when it is determined in Step S32 that an expected operation is not carried out, the tuning unit 13 avoids inputting the machine translation model to the machine translation engine (Step S34).

According to the above-mentioned embodiment, by additionally providing the machine translation control device 10 in the existing machine translation engine 20 and the existing translation DB 30, tuning of a machine translation model based on a similar sentence similar to a frequent sentence and a similar translated sentence thereof is performed using the translation DB 30 without a highly skilled person evaluating the use log or the like as in the related art. Accordingly, it is possible to curb an increase in work time and cost for improvement in translation quality, to achieve improvement in translation quality for a frequent sentence, and to improve convenience for users. By curbing an increase in work time and cost as described above, a technical advantage that it is possible to reduce a process load in a process or the like which will be described later can also be achieved.

With a focus on individual functions, the extraction unit 11 can extract a frequent sentence by performing classification of input sentences to the machine translation. At this time, when there are a plurality of frequent expressions, the extraction unit 11 can appropriately extract a frequent sentence on the additional basis of a frequency of each expression.

The acquisition unit 12 can appropriately acquire a similar sentence on the additional basis of a similarity based on a predetermined criterion even when there are a plurality of similar sentences similar to a frequent sentence.

The tuning unit 13 can appropriately tune the machine translation model 22 in the machine translation engine 20 by performing model learning on the basis of a similar sentence and a similar translated sentence, evaluating the machine translation model subjected to model learning, determining whether an expected operation is carried out as the result of evaluation, and performing control such that the machine translation model is input to the machine translation engine 20 only when the expected operation is carried out.

The block diagram of FIG. 1 which is used to describe the above-mentioned embodiment illustrates blocks of functional units. Such functional blocks (functional units) are realized by an arbitrary combination of hardware and/or software. A means for realizing each functional block is not particularly limited. That is to say, each functional block may be realized by a single device which is physically and/or logically combined or may be realized by two or more devices which are physically and/or logically separated and which are directly and/or indirectly linked to each other (for example, in a wired and/or wireless manner).

For example, the machine translation control device 10 according to the above-mentioned embodiment may serve as a computer that performs the above-mentioned processes of the machine translation control device 10. FIG. 5 is a diagram illustrating an example of the hardware configuration of the machine translation control device 10. The machine translation control device 10 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware of the machine translation control device 10 may be configured to include one or more devices illustrated in the drawing or may be configured to exclude some devices.

The functions of the machine translation control device 10 can be realized by reading predetermined software (program) to the hardware such as the processor 1001 and the memory 1002 and causing the processor 1001 to execute arithmetic operations and to control communication using the communication device 1004 and reading and/or writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the functional units of the machine translation control device 10 may be realized by the processor 1001 and the like.

The processor 1001 reads a program (a program code), a software module, and data from the storage 1003 and/or the communication device 1004 to the memory 1002 and performs various processes in accordance therewith. As the program, a program that causes a computer to perform at least some of the operations described in the above-mentioned embodiment is used. For example, the functional units of the machine translation control device 10 may be realized by a control program which is stored in the memory 1002 and which operates in the processor 1001, or other functional blocks may be realized in the same way. The various processes mentioned above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform a method according to one embodiment of the invention.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage mediums may be, for example, a database, a server, or another appropriate medium including the memory 1002 and/or the storage 1003.

The communication device 1004 is hardware (a transmission and reception device) that performs communication between computers via a wired and/or wireless network and is also referred to as, for example, a network device, a network controller, a network card, or a communication module. For example, the functional units of the machine translation control device 10 may be realized by the communication device 1004 and the like.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The machine translation control device 10 may be configured to include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be mounted as at least one piece of hardware.

While an embodiment of the invention has been described above in detail, it will be apparent to those skilled in the art that the invention is not limited to the embodiment described in this specification. The invention can be altered and modified in various forms without departing from the gist and scope of the invention defined by description in the appended claims. Accordingly, the description in this specification is for exemplary explanation and does not have any restrictive meaning for the invention.

The order of the processing sequences, the sequences, the flowcharts, and the like of the aspects/embodiments described above in this specification may be changed as long as no technical contradictions arise. For example, in the method described in this specification, various steps are described as elements in an exemplary sequence, but the methods are not limited to the described sequence.

Information or the like which is input and output may be stored in a specific place (for example, a memory) or may be managed in a management table. The information or the like which is input and output may be overwritten, updated, or added. The information or the like which is output may be deleted. The information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Transmission of predetermined information (for example, transmission of “X”) is not limited to explicit transmission, and may be performed by implicit transmission (for example, the predetermined information is not transmitted).

Regardless of whether it is called software, firmware, middleware, microcode, hardware description language, or another name, software can be widely construed to refer to commands, a command set, codes, code segments, program codes, a program, a sub program, a software module, an application, a software application, a software package, a routine, a sub routine, an object, an executable file, an execution thread, a sequence, a function, or the like.

Software, commands, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology is included in the definition of the transmission medium.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

Information, parameters, and the like described in this specification may be expressed by absolute values, may be expressed by values relative to a predetermined value, or may be expressed by other corresponding information.

A mobile communication terminal may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any of several other appropriate terms known to those skilled in the art.

The terms “determining” and “determination” which are used in this specification may include various types of operations. The terms “determining” and “determination” may include cases in which judging, calculating, computing, processing, deriving, investigating, looking up (for example, looking up in a table, a database, or another data structure), and ascertaining are considered to be “determined.” The term, “determining” or “determination,” may include cases in which receiving (for example, receiving information), transmitting (for example, transmitting information), input, output, and accessing (for example, accessing data in a memory) are considered “determination.” The terms “determining” and “determination” may include cases in which resolving, selecting, choosing, establishing, comparing, and the like are considered “determination.” That is to say, the terms “determining” and “determination,” can include cases in which a certain operation is considered “determination.”

The expression, “on the basis of,” as used in this specification does not mean “on the basis of only” unless otherwise described. In other words, the expression, “on the basis of,” means both “on the basis of only” and “on the basis of at least.”

When the terms “include” and “including” and modifications thereof are used in this specification or the appended claims, the terms are intended to have a comprehensive meaning similar to the term “comprising.” The term “or” which is used in this specification or the claims is not intended to mean an exclusive logical sum.

In this specification, two or more of any devices may be included unless the context or technical constraints dictate that only one device is included. In the entire present disclosure, singular terms include plural referents unless the context or technical constraints dictate that a unit is singular.

### REFERENCE SIGNS LIST

10: Machine translation control device, 11: Extraction unit, 12: Acquisition unit, 13: Tuning unit, 20: Machine translation engine, 21: Use log, 22: Machine translation model, 30: Translation DB, 1001: Processor, 1002: Memory, 1003: Storage, 1004: Communication device, 1005: Input device, 1006: Output device, 1007: Bus

1. A machine translation control device comprising circuitry configured to:
extract one or more frequent sentences from input sentences to machine translation with reference to a use log in a machine translation engine that performs the machine translation using a machine translation model;
acquire one or more similar sentences which are similar to the frequent sentence and a similar translated sentence which is a translation of the similar sentence from a translation database that stores translation data of the machine translation; and
tune the machine translation model on the basis of the similar sentence and the similar translated sentence.

2. The machine translation control device according to claim 1, wherein the circuitry performs classification of the input sentences to machine translation and extracts the frequent sentence.

3. The machine translation control device according to claim 1, wherein the circuitry extracts the frequent sentence on the additional basis of a frequency of an expression when there are a plurality of frequent expressions.

4. The machine translation control device according to claim 1, wherein the circuitry acquires the similar sentence on the additional basis of a similarity based on a predetermined criterion when there are a plurality of similar sentences similar to the frequent sentence.

5. The machine translation control device according to claim 1, wherein the circuitry performs model learning on the basis of the similar sentence and the similar translated sentence, evaluates the machine translation model subjected to model learning, and tunes the machine translation model in the machine translation engine on the basis of a result of evaluation.

6. The machine translation control device according to claim 1, wherein the circuitry refers to the use log in the machine translation engine which is provided outside the machine translation control device, and
wherein the circuitry acquires the similar sentence and the similar translated sentence from the translation database which is provided outside the machine translation control device.

7. The machine translation control device according to claim 2, wherein the circuitry extracts the frequent sentence on the additional basis of a frequency of an expression when there are a plurality of frequent expressions.
